(19) United States
(12) Patent Application Publication
(10) Pub. No.: US 2006/0157635 A1
(43) Pub. Date: Jul. 20, 2006

(54) Mold battery having adjustable pivots

(76) Inventor: Chris Flanagan, Hempstead, TX (US)

Correspondence Address: Stephen S. Mosher;Whitaker, Chalk, Swindle & Sawyer, LLP, 3500 City Center Tower II, 301 Commerce Street, Fort Worth, TX, 76102-4186, US

(21) Appl. No.: 11/036,841

(22) Filed: Jan. 14, 2005

(51) Int. Cl. B28B 7/04

(52) U.S. Cl. 249/120; 264/299; 264/334

(57) ABSTRACT

A mold battery for molding planar products in cavities defined by adjacent mold flaps is disclosed, wherein each end of each mold flap is slotted in a lower portion thereof to receive a pivot which can be fastened at a desired position within the slot, thus easily and quickly providing adjustable mold flap locations which improve the edge sealing of one mold flap to another. A method of using slotted pivots to adjust the mold flaps of the mold battery is disclosed as is a method of using the adjusted mold battery.

### BACKGROUND OF THE INVENTION

1. Field of the Invention

The present invention relates to the field of molding multiple products simultaneously. More particularly, the present invention relates to the multiple molding of panel-shaped concrete products, within cavities defined by mold flaps arranged in an adjacent manner, commonly termed a mold battery.

2. Description of the Prior Art

A mold battery comprises multiple mold flaps having a generally vertically planar shape, arranged side-by-side. By contacting one another at side seals and a bottom seal, and by providing an opening between adjacent top edges, multiple mold cavities are created. This arrangement makes it convenient to pour one batch of concrete onto the top of the mold battery, filling many cavities simultaneously. Excess concrete can be screeded off, imparting a straight top surface to the molded products.

The internal mold surface of a mold flap can comprise a sculpted surface, meant to impart to the molded product an appearance which simulates stone, brick, or the like. The mold flap can be made of an elastomeric material, which aids in the release of the molded product and which seals well along the sides and bottom.

A complete mold battery assembly comprises a base frame to support the weight of the mold flaps and panel products. The assembly could also comprise a means for clamping the mold flaps against one another, especially during the pouring of the concrete. This clamping means must thereafter disengage.

Mold batteries of prior art have comprised some means of mold flap rotation, within the base frame, in a fashion similar to turning a page in a book. In this way, the mold flaps can be aligned and brought together, and also later opened to harvest the cured molded products.

Some rotating prior art designs have used permanent hinges to rotate the mold flaps. However, those designs have proved ineffective in practice, since it is nearly impossible to predict the desirable hinge location, due to variables in the manufacturing of each mold flap. It is a well-known problem that several small dimensional errors can accumulate to cause a large error, resulting in the misfit of some mold flaps.

A prior art mold battery design by Muidrey, U.S. Pat. No. 4,614,325 features an adjustable hinge, which is a component of the base frame. The present invention will be demonstrated to comprise a new adjustable pivot assembly, which is a component of the mold flap.

### SUMMARY OF THE INVENTION

An objective of the present invention is to improve the effectiveness of the seal of one mold flap to another. This is accomplished by providing a mold flap having an adjustable pivot.

Another objective of the present invention is to provide a mold flap having an adjustable pivot which is easy to adjust. This is accomplished by utilizing a fastening means to secure the pivot at a desired location, using conventional hand tools.

Yet another objective of the present invention is to provide a mold flap having an adjustable pivot which is quick to adjust. This is accomplished by utilizing a fastening means which can be used to make the adjustment in a matter of minutes.

These and other features, aspects, and advantages of the present invention will become better understood with regard to the following description, appended claims, and accompanying drawings.

### BRIEF DESCRIPTION OF THE DRAWINGS

The following drawings describe the present invention:

FIG. 1 is an exploded perspective view of a mold flap according to the present invention;

FIG. 2 is a partial perspective view of the adjustable pivot assembly of FIG. 1;

FIG. 3 is a perspective view of the mold flap of FIG. 1 fitted into a base showing the pivoting action;

FIG. 4 is a perspective view of the base of FIG. 3 fitted with three pivoting mold flaps and one fixed mold flap;

FIG. 5 is a side elevational view of the FIG. 4 assembly, showing pivots secured centrally within slotted openings;

FIG. 6 is a side elevational view of the base, fitted alternately with thick flaps having pivots secured to the left within slotted openings;

FIG. 7 is a side elevational view of the base, fitted alternately with narrow flaps having pivots secured to the right within slotted openings;

FIG. 8 is an exploded perspective view of a mold flap having an alternate adjustable pivot construction;

FIG. 9 is a partial perspective view of the adjustable pivot assembly of FIG. 8;

FIG. 10 is an exploded perspective view of a mold flap having an alternate adjustable pivot construction;

FIG. 11 is a partial cross sectional view of the adjustable pivot assembly of FIG. 10;

FIG. 12 is a perspective view of the mold battery of the present invention having a clamping assembly for holding flaps together.

### REFERENCE NUMERALS USED IN THE DRAWINGS

The following is a description of the referenced parts:
10 mold flap
11 top edge
12 side seal
13 bottom seal
14 leg
15 cavity
16 slotted opening
18 fixed mold flap
19 lug
20 thick mold flap
26 slotted opening
28 thick fixed flap
30 narrow mold flap
36 slotted opening
38 narrow fixed flap
40 mold flap
46 slotted opening
50 mold flap
56 slotted opening
60 threaded shank
61 bolt
62 washer
64 pivot tube
66 nut
67 pin
68 rod
69 wing nut
70 shoulder bolt
71 threaded shank
72 pivot shoulder
73 head
76 nut
80 pivot nut
81 pivot body
82 head
86 bolt
90 base
91 hole
92 pivot hole
N narrow width
P direction
T thick width
W width

### DETAILED DESCRIPTION OF THE INVENTION

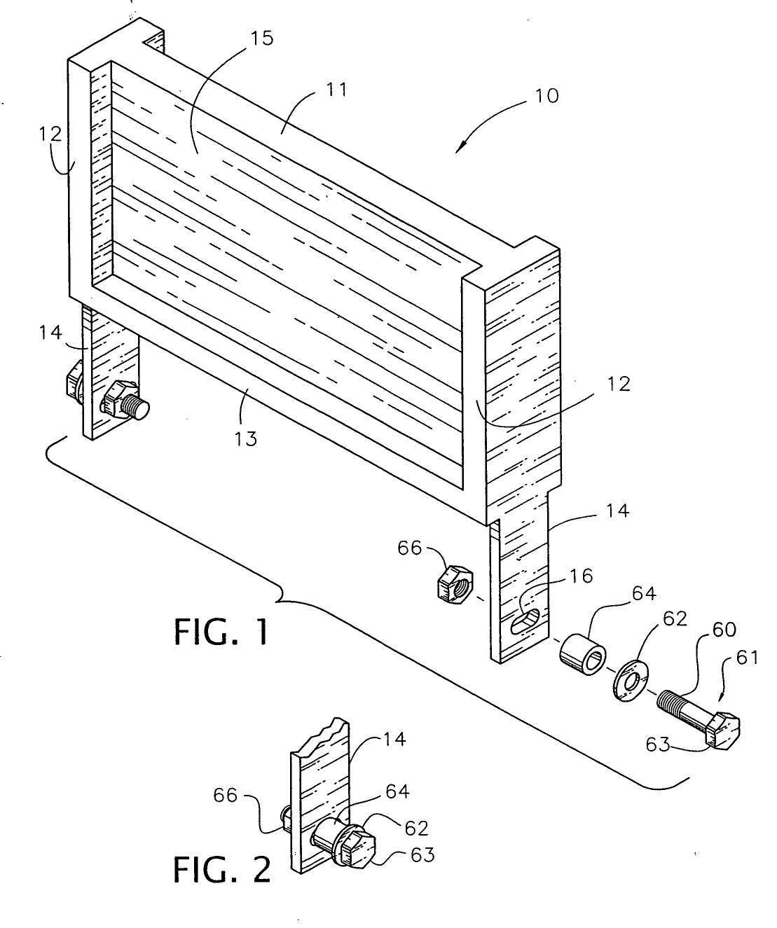

FIG. 1. shows one embodiment of the present invention which comprises a mold flap 10, which has a generally vertical planar shape. The mold flap is preferably fabricated of an elastomeric material such as polyurethane, which is wear resistant, is flexible for ease in removing cast product, and which provides fidelity in the molding surface. The mold flap has a top edge 11, two side seals 12, and a bottom seal 13. Each seal can be comprised of a sealing surface, especially if the mold is fabricated of an elastomeric material, or each seal can be comprised of a strip of compliant material. The central area of the mold flap comprises a concave shaped cavity 15 which is negatively sculpted or imparting a positive texture to the molded product. All of the features on the shown side of the mold flap are also on the opposite side. In this way, a mold cavity can be created by sealing two mold flaps adjacent to one another. At each end of the mold flap, there are legs 14, each having a slotted opening 16, whose long axis is generally horizontal. The slotted opening may have dimensions of ½ inch×⅞ inch, but will work with other suitable dimensions. An adjustable pivot assembly is attached through the slotted opening, comprising a bolt 61 sized to fit through the slotted opening. The bolt has a head 63, and a threaded shank 60, on which is placed a washer 62, and a pivot tube 64. The pivot tube is a hollow cylinder having an inside diameter sized to receive the bolt, and an outside diameter of a size which would prevent it from passing though the slotted opening. By passing the bolt through the pivot tube and slotted opening, and securing it with a nut 66, as shown in FIG. 2, a pivot is provided at a particular location along the slotted opening. Thus, it will be realized that the location of the pivot is adjustable, to suit the desired fit of one mold flap to another.

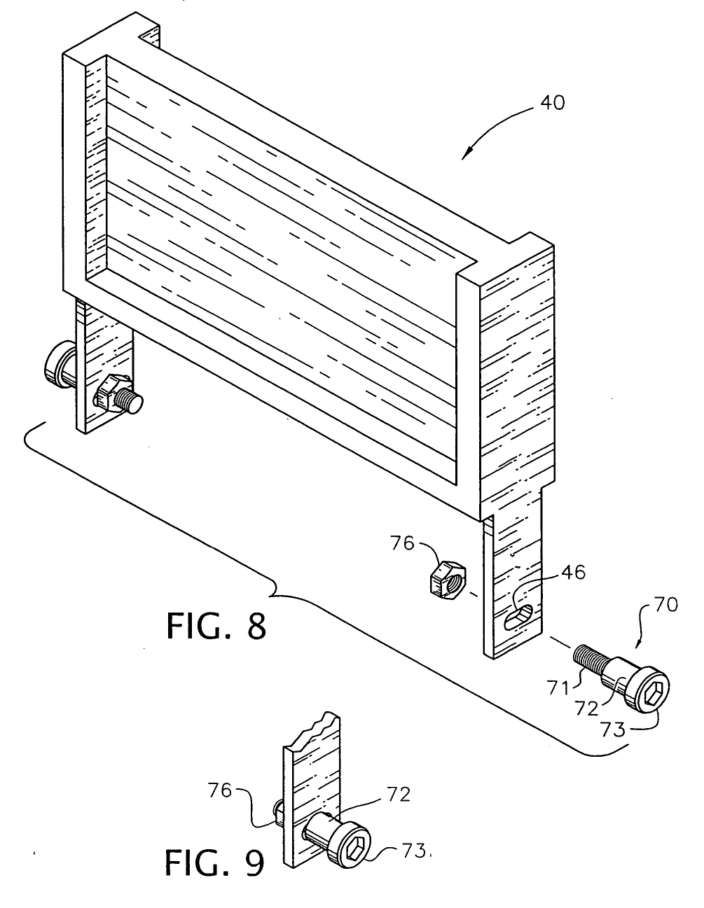

Another embodiment, which would work equally well, would comprise a bolt with a head sufficiently large, so that the washer 62 could be eliminated. Other embodiments, comprising alternate hardware will be shown later in FIGS. 8 thru 11.

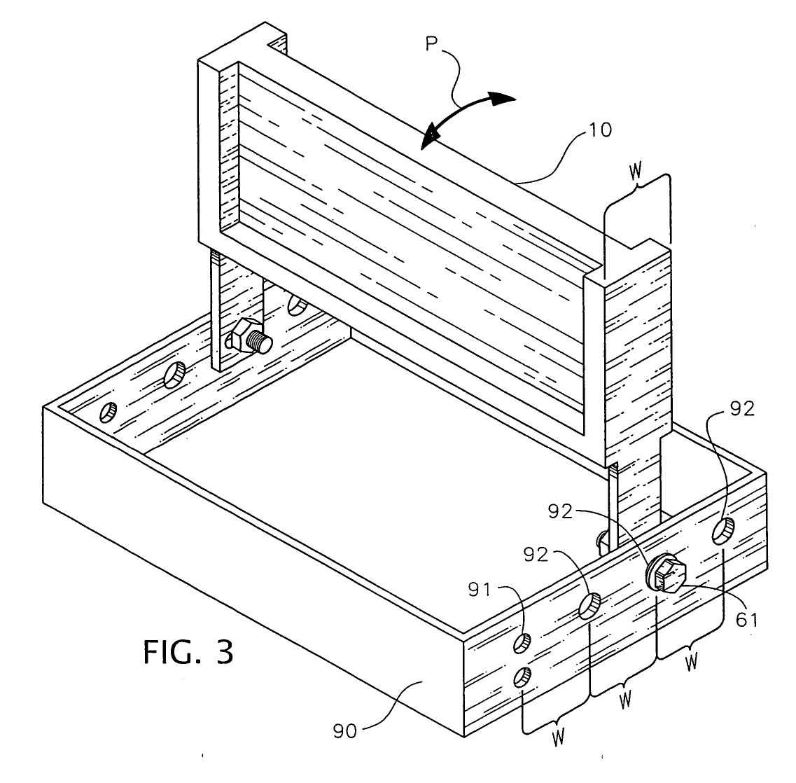

FIG. 3 shows a base 90 which is a structure for providing pivoting support for one or more mold flaps 10 by means of pivot holes 92 equally spaced apart from one another at a distance referenced by character W, wherein the nominal thickness of the mold flap is equal to W. One mold flap is shown supported in the base by the adjustable pivots fitted through the pivot holes, so that the mold flap may rotate in the direction shown by double-headed arrow referenced by character P. Note that he length of the pivot tube (reference numeral 64 in FIG. 1) must be longer than the thickness of the all of the base, to prevent binding. Also the diameter of the pivot hole must be greater than the diameter of the pivot tube.

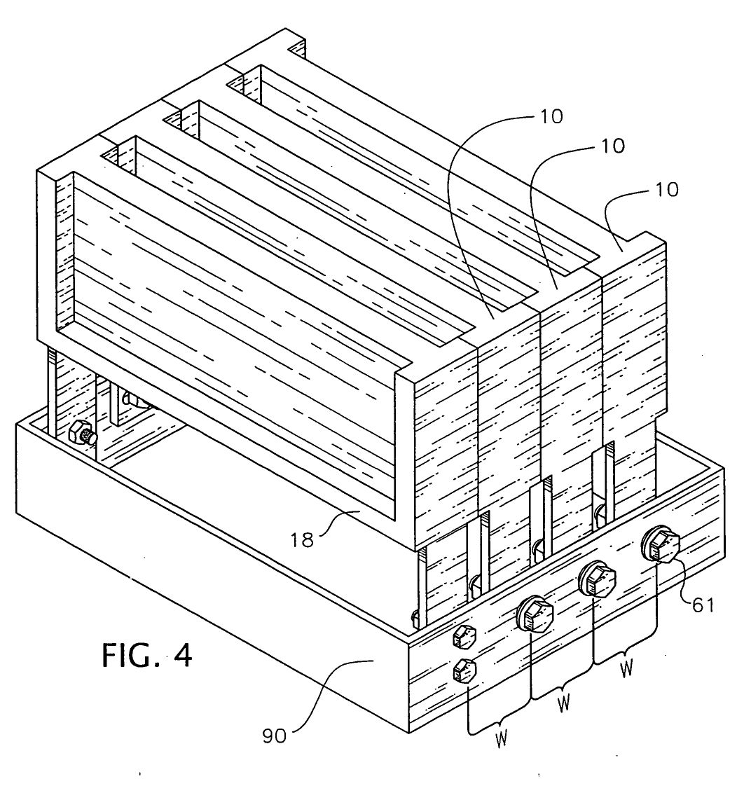

FIG. 3 also shows holes 91 for securing a fixed mold flap (shown by reference numeral 18 in FIG. 4). The fixed mold flap is similar to mold flap 10, except that it has no adjustable pivots, but instead has holes to match holes 91 for rigid mounting in a vertical position, against which adjacent mold flaps 10 may pivot.

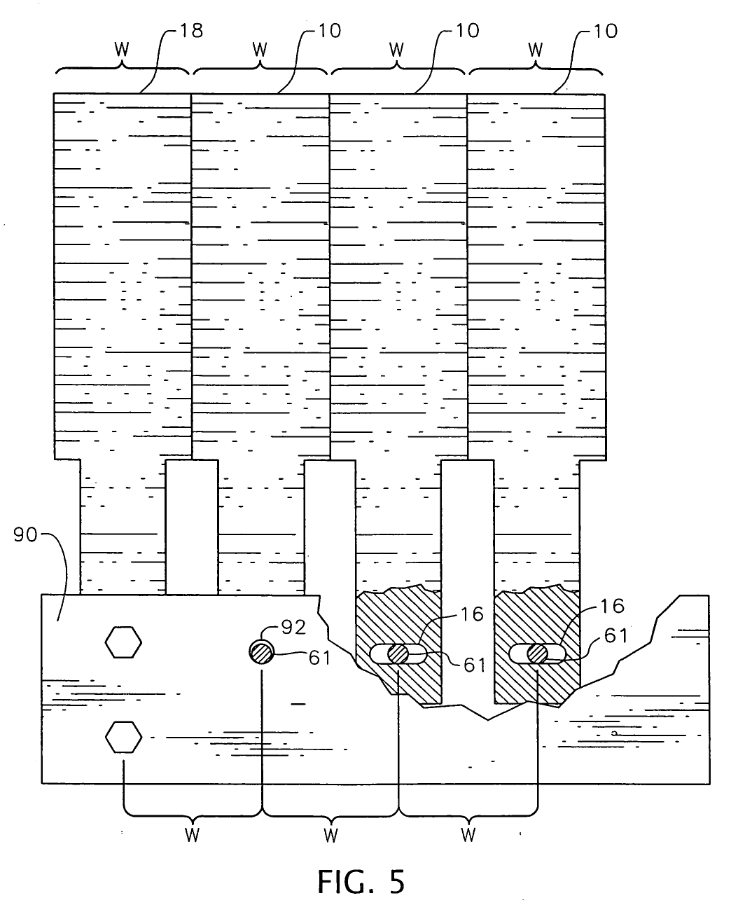

FIG. 4 shows the fixed flap 18 and three of mold flaps 10 fitted into the base 90. The same embodiment is shown as a cross-sectional side view in FIG. 5. Where each of the adjustable pivots is secured by bolts 61 centered in the slotted openings 16.

FIG. 5 shows a side view of the embodiment of FIG. 4. The mold flaps 10, each have a width noted as W and the pivot holes 92 are spaced equally at the same distance noted by W. The pivots are adjusted by loosening the hardware and retightening at the desired positions. Thus, each of the mold flaps 10 are able to fit and seal well together by securing the bolts 61 centrally within slotted openings 26 thus providing an adjustable location of the mold flaps centrally.

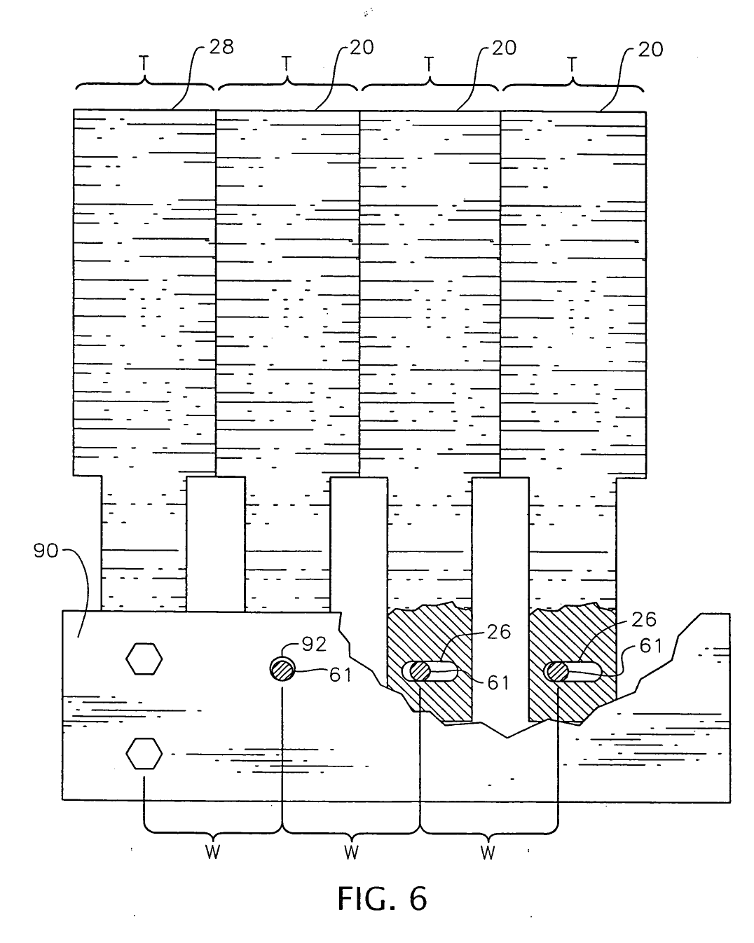

FIG. 6 shows a different set of mold flaps which are thick flaps 20, each having a slightly thicker width denoted as T. These are fitted into the same base 90 as was shown in FIG. 5 having pivot holes 92 spaced equally at the distance noted by W (wherein T is greater than W.) Therefore, the thick flaps would not fit properly together, were it not for the present invention, whereby the pivot locations are adjusted by loosening the hardware and retightening at the desired positions. Thus, each of the thick flaps 20 are able to fit and seal well together by securing the bolts 61 toward the left within-slotted openings 26 thus providing an adjustable location of the thick flaps toward the right.

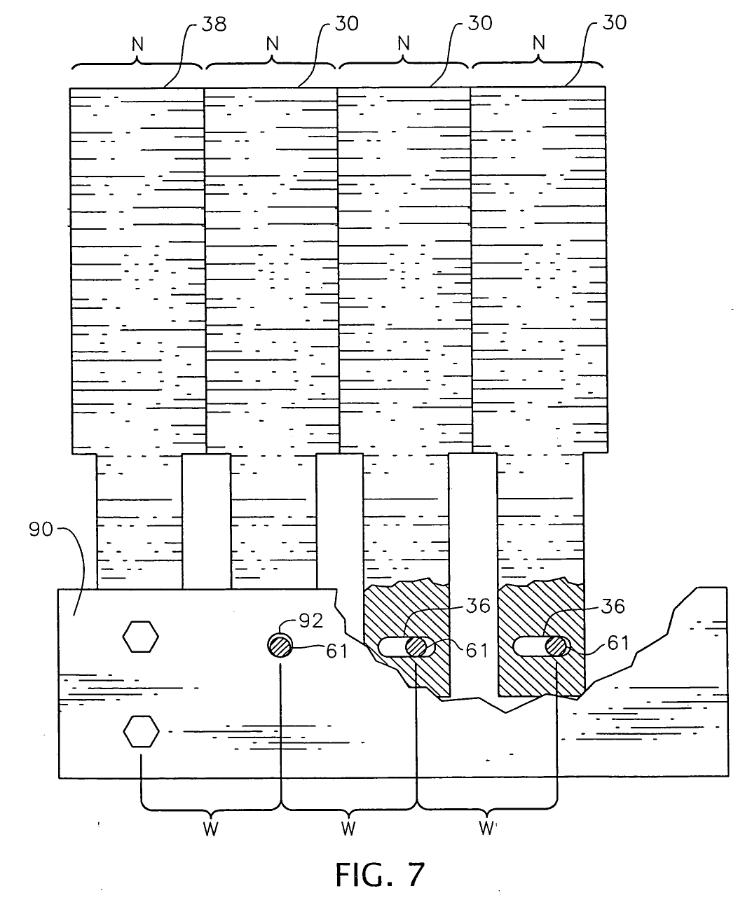

By contrast, FIG. 7 shows yet a different set of mold flaps which are narrow flaps 30, each having a slightly narrower width denoted as N. These are fitted into the same base 90 as was shown in FIG. 5 having pivot holes 92 spaced equally at the distance noted by W (wherein N is less than W.) Therefore, the narrow flaps would not fit properly together, were it not for the present invention, whereby the pivot locations are adjusted by loosening the hardware and retightening at the desired positions. Thus, each of the narrow flaps 30 are able to fit and seal well together by securing the bolts 61 toward the right within slotted openings 36 thus providing an adjustable location of the narrow flaps toward the left.

Having shown, by way of illustration in FIGS. 6 and 7, how thick mold flaps 20 and narrow mold flaps 30 are accommodated by the adjustable pivots of the present invention, it can now be appreciated how the present invention provides adjustment for any combination of thick or narrow mold flaps. Furthermore, the adjustable pivots of the present invention can provide flush mold seal fitting between mold flaps 10 in spite of other variations, such as where the pivot hole 92 spacings are not equal, or where the thickness of a mold flap on one end is different from the thickness at the other end.

The adjustable pivot of the present invention can also correct for dimensional variations over a period of time. It is well known that the dimensions of mold flaps fabricated of an elastomeric material can change overtime. For example, the thickness of the mold flap can become more narrow due to compression set caused by repeated and prolonged clamping forces. On the other hand, the mold flaps may increase in dimension due to swelling caused by exposure to water, chemicals, or temperature changes. If the mold flap dimensions change over time then the flaps will not seal well. However the adjustable pivots of the present invention may be loosened, repositioned, and retightened in a matter of minutes.

An alternate embodiment of the present invention is shown in FIG. 8 where a mold flap 40 having a slotted opening 46 is fitted with a shoulder bolt 70 having a threaded shank 71, a pivot shoulder 72 and a head 73. The shoulder bolt passes through the slotted opening and is secured by a nut 76. The secured adjustable pivot of this embodiment is shown in FIG. 9.

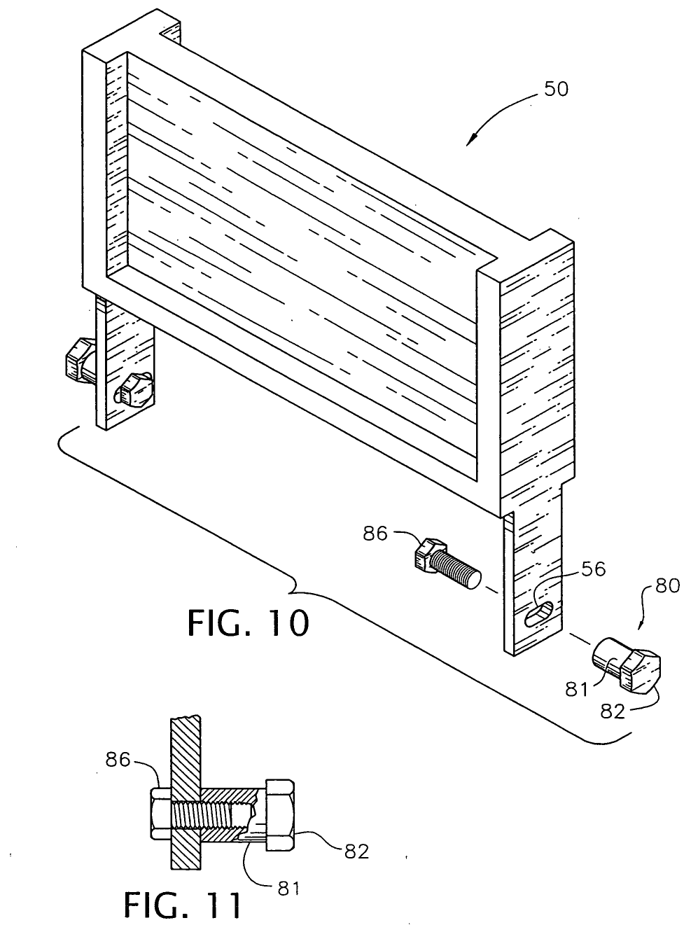

An alternate embodiment of the present invention is shown in FIG. 10 where a mold flap 50 having a slotted opening 56 is fitted with a bolt 86 which passes through the slotted opening and is secured by a pivot nut 80 having a female thread (not visible in this view) and a pivot body 81 and a head 82. The secured adjustable pivot of this embodiment is shown in cross section in FIG. 11.

Several embodiments of the adjustable pivot assembly have been illustrated in which various hardware parts have been utilized to provide a pivot. For example, FIG. 1 shows a pivot tube 64, and FIG. 8 shows a pivot shoulder 72, and FIG. 10 shows a pivot body 81. In every embodiment, a pivot is provided which is defined as generally cylindrical having a diameter suited to fit through the pivot hole (92 in FIG. 3.) for supporting the weight of the mold flap 10 and for providing pivoting action to rotate the mold flap.

Several embodiments of the adjustable pivot assembly have been illustrated in which the fastening of the adjustable pivot is facilitated by applying torque to a head (63 in FIG. 1, 73 in FIG. 8, and 82 in FIG. 10.) However, the present invention would work equally well having an adjustable pivot without a head. Other means of applying torque to fasten, such as grasping, or using a screw slot, or using a spanner hole, would work equally well.

Referring again to FIGS. 3 and 4, the present invention benefits by attaching the fixed mold flap 18 rigidly and vertically to the base frame 90 by means of fasteners through holes 91. Fixing at least one mold flap prevents the rest of the mold flaps from leaning over away from vertical, especially when they are all clamped together during the pouring and filling of the mold cavities. The mold flap which is fixed to the base frame could be one on the end, in which case the other mold flaps would later separate in one direction away from that end mold member, in order to remove each molded product. Or, the fixed mold flap could be one of the middle mold flaps, in which case the other mold flaps would separate in two directions, away from the fixed middle mold flap.

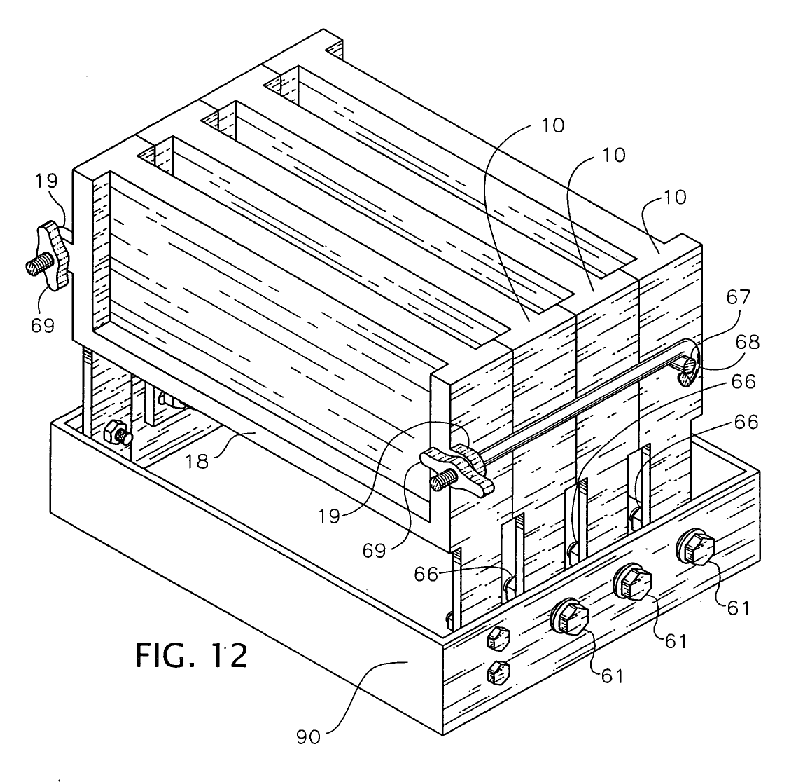

The present invention comprises a clamping means for clamping the mold flaps together prior to pouring and filling. One version of the clamping means is shown in FIG. 12, having a lug 19 attached to each end of mold flap 18. There is a pin 67 attached to each end of the last mold flap 10. On each end, there is a rod 68 having a hooked end secured around the pin, and a threaded end passing through a hole in the lug. By turning a wing nut 69 against the lug on each end, the flaps can be clamped tightly together. Alternate versions of a clamping means could be comprised of a chain or cable, on two sides (or completely surrounding all of the mold members) and joining with a screw, lever, ratchet, over-the-center latch, or other well-known mechanisms for drawing a chain or cable tight.

Having demonstrated several embodiments of the present invention, it can now be understood how one may adjust a mold battery of the present invention, comprising the steps of: Providing a mold battery comprised of two or more mold flaps each having a generally planar shape oriented vertically, each mold flap having at each end: a slotted opening having a long axis which is generally horizontal, a pivot having a generally cylindrical shape, a fastening means for fastening the pivot to the slotted opening at an adjusted position; wherein further providing a base for pivotal attaching each mold flap wherein the base has pivot holes though which each pivot is rotatably guided, then providing a clamping means for clamping the mold flaps together, then uncapping the clamping means, then loosening each fastening means, whereby each pivot is free to move horizontally along its respective slotted opening, then clamping the flaps together with the clamping means, whereby mold flaps can make desirable planar contact to one another, unrestrained by loosened pivots, and finally fastening each fastening means, whereby each pivot is secured at the adjusted position, whereby, if the clamping means is uncapped, then each mold flap can be pivoted to an open position, and whereby if the mold flaps are clamped together with the clamping means, the mold battery is adjusted by the adjusted position of each pivot.

Also, the products which can be cast by the present invention are improved by being cast in a mold battery that has been adjusted by: Providing a mold battery comprised of two or more mold flaps each having a generally planar shape oriented vertically, each mold flap having a cavity, and each mold flap having at each end: a slotted opening having a long axis which is generally horizontal, a pivot having a generally cylindrical shape, a fastening means for fastening the pivot to the slotted opening at an adjusted position; wherein further providing a base for pivotal attaching each mold flap wherein the base has pivot holes though which each pivot is rotatably guided, then providing a clamping means for clamping the mold flaps together, then uncapping the clamping means, then loosening each fastening means, whereby each pivot is free to move horizontally along its respective slotted opening, then clamping the flaps together with the clamping means, whereby mold flaps can make desirable planar contact to one another, unrestrained by loosened pivots, and finally fastening each fastening means, whereby each pivot is secured at the adjusted position, then pouring a hard enable material into the cavities between mold flaps, then waiting for the hard enable material to harden, then uncapping the clamping means, then pivoting each mold flap to an open position, and finally removing the hardened product.

Thus, it can now be appreciated how the present invention offers many improvements and advantages in adjusting, aligning, sealing, and separating the mold flaps of a mold battery. The applications of the present invention are not limited to concrete molding, but can also benefit molding and casting of other materials in planar and non-planar shapes. While the above descriptions and embodiments contain many specific features by way of example, they should not be construed as limitations on the scope of the invention. Many other variations are possible within the scope of the following claims.

What is claimed is:

1. A mold flap for a mold battery having two or more mold flaps pivotally supported adjacent each other on a base, comprising:
a. a mold flap having a generally planar shape oriented vertically and supported at a lower end of first and second legs thereof
b. a slotted opening in a lower end of each first and second leg and having a long axis which is generally horizontal;
c. a pivot for each slotted opening disposed on the base and having a generally cylindrical shape; and
d. a fastening means for fastening the pivot to the slotted opening at a selected position.

2. The mold flap of claim 1, wherein the pivot comprises a hollow cylinder, and wherein the fastening means comprises a threaded bolt in mating union with a threaded nut, the threaded bolt having a size suited to pass though the hollow cylinder and the slotted opening, the threaded bolt passing through the hollow cylinder and the slotted opening.

3. The mold flap of claim 1, wherein the pivot comprises a male threaded stud, having of a size suited to pass though the slotted opening, and wherein the fastening means comprises a threaded nut in mating union with the threaded stud, wherein the threaded stud passes though the slotted opening.

4. The mold flap of claim 3, wherein the pivot comprises a head for applying a fastening torque.

5. The mold battery of claim 1, wherein the pivot comprises a female threaded opening, and wherein the fastening means comprises a threaded bolt in mating union with the threaded opening, wherein the threaded bolt is of a size suited to pass though the slotted opening, and wherein the threaded bolt passes through the slotted opening.

6. The mold flap of claim 5, wherein the pivot comprises a head for applying a fastening torque.

7. A mold flap for a mold battery having two or more mold flaps pivotally supported adjacent each other on a base, comprising:
a. a mold flap having a generally planar shape oriented vertically and supported at a lower end of first and second legs thereof;
b. a slotted opening in a lower end of each first and second leg and having a long axis which is generally horizontal;
c. a pivot for each slotted opening, disposed on the base and having a pivot diameter;
d. a fastening means for fastening the pivot to the slotted opening at a selection position; and
e. the base having a pivot hole, wherein the pivot hole has a diameter larger than the pivot diameter, wherein the pivot is in the pivot hole, whereby the mold flap is guided to rotate.

8. The mold flap of claim 7, wherein the pivot comprises a hollow cylinder, and wherein the fastening means comprises a threaded bolt in mating union with a threaded nut, the threaded bolt having a size suited to pass though the hollow cylinder and the slotted opening, the threaded bolt passing through the hollow cylinder and the slotted opening.

9. The mold flap of claim 7, wherein the pivot comprises a male threaded stud, having of a size suited to pass though the slotted opening, and wherein the fastening means comprises a threaded nut in mating union with the threaded stud, wherein the threaded stud passes though the slotted opening.

10. The mold flap of claim 9, wherein the pivot comprises a head for applying a fastening torque.

11. The mold battery of claim 7 wherein the pivot comprises a female threaded opening, and wherein the fastening means comprises a threaded bolt in mating union with the threaded opening, wherein the threaded bolt is of a size suited to pass though the slotted opening, and wherein the threaded bolt passes through the slotted opening.

12. The mold flap of claim 11, wherein the pivot comprises a head for applying a fastening torque.

13. A mold flap for a mold battery having two or more mold flaps pivotally supported adjacent each other on a base, comprising:
a. a mold flap having a generally planar shape oriented vertically, wherein the mold flap has a leg extending downward from each one of a first end and a second end;
b. a first slotted opening having a long axis which is generally horizontal, wherein the first slotted opening is in a lower end of the first leg of the mold flap;
c. a second slotted opening having a long axis which is generally horizontal, wherein the second slotted opening is in a lower end of the second leg of the mold flap;
d. a first pivot for the first slotted opening, disposed on the base and having a first pivot diameter;
e a second pivot at the second slotted opening, disposed on the base and having a second pivot diameter;
f. a first fastening means for fastening the first pivot to the first slotted opening at a first selected position on the base; and
g. a second fastening means for fastening the second pivot to the second slotted opening at second selected position on the base.

14. A mold flap for a mold battery having two or more mold flaps pivotally supported adjacent each other on a base, comprising:
a. a mold flap having a generally planar shape oriented vertically, wherein the mold flap has leg extending downward from each one of a first end and a second end;
b. a first slotted opening having a long axis which is generally horizontal, wherein the first slotted opening is in a lower end of the first leg of the mold flap;
c. a second slotted opening having a long axis which is generally horizontal, wherein the second slotted opening is in a lower end of the second leg of the mold flap;
d. a first pivot for the first slotted opening, disposed on the base and having a first pivot diameter;
e. a second pivot at the second slotted opening, disposed on the base and having a second pivot diameter;
f. a first fastening means for fastening the first pivot to the first slotted opening at a first selected position on the base;
g. a second fastening means for fastening the second pivot to the second slotted opening at a second selected position on the base; and
h. the base having a first pivot hole and a second pivot hole, wherein the first pivot hole has a diameter larger than the first pivot diameter, wherein the second pivot hole has a diameter larger than the second pivot diameter, wherein the first pivot is in the first pivot hole, and wherein the second pivot is in the second pivot hole, whereby the mold flap is guided to rotate.

15. A method of adjusting a mold battery, comprising the steps of:
a. providing a mold battery comprised of two or more mold flaps each having a generally planar shape oriented vertically and supported at a lower end of first and second legs thereof, each mold flap having at a lower end of each first and second leg at each end: a slotted opening having a long axis which is generally horizontal, a pivot having a generally cylindrical shape, a fastening means for fastening the pivot to the slotted opening at an adjusted position; wherein further providing a base for pivotal attaching each mold flap wherein the base has pivot holes though which each pivot is rotatably guided,
b. providing a clamping means for clamping the mold flaps together,
c. uncapping the clamping means,
d. loosening each fastening means, whereby each pivot is free to move horizontally along its respective slotted opening,
e. clamping the flaps together with the clamping means, whereby mold flaps can make desirable planar contact to one another, unrestrained by loosened pivots,
f. fastening each fastening means, whereby each pivot is secured at said adjusted position, whereby, if the clamping means is uncapped, each mold flap can be pivoted to an open position, and whereby if the mold flaps are clamped together with the clamping means, the mold battery is adjusted by the adjusted position of each pivot.

16. A method of casting a product using an adjustable mold battery, comprising the steps of:
a. providing a mold battery comprised of two or more mold flaps each having a generally planar shape oriented vertically and supported at a lower end of first and second legs thereof, each mold flap having a cavity, each mold flap having at a lower end of each first and second leg at each end: a slotted opening having a long axis which is generally horizontal, a pivot having a generally cylindrical shape, a fastening means for fastening the pivot to the slotted opening at an adjusted position; wherein further providing a base for pivotal attaching each mold flap wherein the base has pivot holes though which each pivot is rotatably guided;
b. providing a clamping means for clamping the mold flaps together;
c. uncapping the clamping means;
d. loosening each fastening means, whereby each pivot is free to move horizontally along its respective slotted opening;
e. clamping the flaps together with the clamping means, whereby mold flaps can make desirable planar contact to one another, unrestrained by loosened pivots;
f. fastening each fastening means, whereby each pivot is secured at said adjusted position;
g. pouring a hard enable material into the cavities between mold flaps;
h. waiting for the hard enable material to harden;
i. uncapping the clamping means;
j. pivoting each mold flap to an open position; and
k. removing the hardened product.
